(19) United States
(12) Patent Application Publication
(10) Pub. No.: US 2016/0071302 A1
(43) Pub. Date: Mar. 10, 2016

(54) SYSTEMS AND METHODS FOR CINEMATIC DIRECTION AND DYNAMIC CHARACTER CONTROL VIA NATURAL LANGUAGE OUTPUT

(71) Applicant: Mark Stephen Meadows, Emeryville, CA (US)

(72) Inventor: Mark Stephen Meadows, Emeryville, CA (US)

(21) Appl. No.: 14/849,140

(22) Filed: Sep. 9, 2015

Related U.S. Application Data
(60) Provisional application No. 62/048,170, filed on Sep. 9, 2014.

(51) Int. Cl. G06T 13/40; G10L 21/10; G10L 25/63

(52) U.S. Cl. CPC G06T 13/40; G10L 25/63; G10L 21/10

(57) ABSTRACT

A method for executing cinematic direction and dynamic character control via natural language output is provided. The method includes generating a first set of instructions for animation of characters and a second set of instructions for animation of environments; extracting a first set of dialogue elements from a conversant input received in an affective objects module of the processing circuit; extracting a second set of dialogue elements from a natural language system output; analyzing the first and second sets of dialogue elements by an analysis module in the processing circuit for determining emotional content data used to generate an emotional content report; analyzing the first and second sets of dialogue elements by the analysis module in the processing circuit for determining duration data used to generated a duration report; and animating the characters and the environments based on the emotional content report and the duration report.

### CLAIM OF PRIORITY UNDER 35 U.S.C. §119

The present Application for Patent claims priority to U.S. Provisional Application No. 62/048,170 entitled “SYSTEMS AND METHODS FOR CINEMATIC DIRECTION AND DYNAMIC CHARACTER CONTROL VIA NATURAL LANGUAGE PROCESSING”, filed Sep. 9, 2014, and hereby expressly incorporated by reference herein.

### FIELD

The present application relates to systems and methods for cinematic direction and dynamic character control via natural language output.

### BACKGROUND

Applications executed by computing devices are often used to control virtual characters. Such computer-controlled characters may be used, for example, in training programs, or video games, or in educational programs, or in personal assistance. These applications that control virtual characters may operate independently or may be embedded in many devices, such as desktops, laptops, wearable computers, and in computers embedded into vehicles, buildings, robotic systems, and other places, devices, and objects. Many separate characters may also be included in the same software program or system of networked computers such that they share and divide different tasks and parts of the computer application. These computer-controlled characters are often deployed with the intent to carry out dialogue and engage in conversation with users, also known as human conversants, or the computer-controlled characters may be deployed with the intent to carry out dialogue with other computer-controlled characters. This interface to information that uses natural language, in English and other languages, represents a broad range of applications that have demonstrated significant growth in application, use, and demand.

Interaction with computer-controlled characters has been limited in sophistication, in part, due to the inability of computer-controlled characters to both recognize and convey nontextual forms of communication missing in natural language, and specifically textual natural language. Many of these non-textual forms of communication that people use when speaking to one another, commonly called “body language,” or “tone of voice” or “expression” convey a measurably large set of information. In some cases, such as sign language, all the data of the dialogue may be contained in non-textual forms of communication. In addition, as is clear in cinematography, video games, virtual worlds, and other places, devices, and objects, non-textual forms of communication extend beyond the character talking. These may include non-textual forms of communication such as camera control, background music, background sounds, the adjustment or representation of the background itself, lighting, and other forms.

Computer-controlled elements of communication that are non-textual in nature are costly to build, time-intensive to design, and the manual construction of each non-textual form of communication that maps to textual elements of dialogue creates an overwhelming amount of work to convey in a manner that is legible and communicative. The costs associated with authoring the body language and other non-textual elements of communication is a significant factor in constraining developers of computer-controlled characters and computer-controlled environments, and restricts the options available to better convey information in narrative, training, assistance, or other methods of communication. Developers of computer-controlled characters are very interested in increasing the sophistication and variety of computer-controlled character dialogue and creating the illusion of personality, emotion and intelligence, but that illusion is quickly dispelled when the character does not gesture, or repeats animated movements, or lacks facial expression, or begins to engage with a user that is outside the range of content that was manually authored for the computer-controlled character. This is also the case for other means of representing the cinematic arts, such as camera control in a virtual environment to best convey a sense of intimacy or isolation, lighting, and the animation and control of background scene, objects and other elements used to communicate.

While it is physically possible to simply author an increasing number of non-textual elements of communication that a computer-controlled character, object, or environment can recognize and use to communicate, there are substantial limits on the amount of investment of time and energy developers may put in these systems, making the increase in quality prohibitively expensive.

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts or examples of one or more implementations in a simplified form as a prelude to the more detailed description that is presented later.

Various aspects of the disclosure provide for a computer implemented method for executing cinematic direction and dynamic character control via natural language output. The method is executed on a processing circuit of a computer terminal comprising the steps of generating a first set of instructions for animation of one or more characters; generating a second set of instructions for animation of one or more environments; extracting a first set of dialogue elements from a conversant input received in an affective objects module of the processing circuit; extracting a second set of dialogue elements from a natural language system output; analyzing the first and second sets of dialogue elements by an analysis module in the processing circuit for determining emotional content data, the emotion content data used to generate an emotional content report; analyzing the first and second sets of dialogue elements by the analysis module in the processing circuit for determining duration data, the duration data used to generated a duration report; and animating the one or more characters and the one or more environments based on the emotional content report and the duration report.

According to one feature, the affective objects module in the computer terminal comprises a parsing module, a voice interface module and a visual interface module.

According to another feature, the conversant input is selected from at least one of a verbal communication and a visual communication from a user.

According to yet another feature, the one or more characters are selected for at least a virtual character and a physical character.

According to yet another feature, the one or more environments are selected for at least a virtual environment and a physical environment.

According to yet another feature, the natural language system output is a physical character such as a robot or a robotic system.

According to another aspect, a non-transitory computer-readable medium with instructions stored thereon is provided. The instructions executed by a processor perform the steps comprising generating a first set of instructions for animation of one or more characters; generating a second set of instructions for animation of one or more environments; extracting a first set of dialogue elements from a conversant input received in an affective objects module of the processing circuit; extracting a second set of dialogue elements from a natural language system output; analyzing the first and second sets of dialogue elements by an analysis module in the processing circuit for determining emotional content data, the emotion content data used to generate an emotional content report; analyzing the first and second sets of dialogue elements by the analysis module in the processing circuit for determining duration data, the duration data used to generate a duration report; and animating the one or more characters and the one or more environments based on the emotional content report and the duration report.

According to one feature, the conversant input is selected from at least one of a verbal communication and a visual communication from a user.

According to another feature, the one or more characters are selected for at least a virtual character and a physical character.

According to yet another feature, the one or more environments are selected for at least a virtual environment and a physical environment.

According to yet another feature, the natural language system output is a physical character such as a robot or a robotic system.

According to yet another aspect, a computer terminal for executing cinematic direction and dynamic character control via natural language output is provided. The terminal includes a processing circuit; a communications interface communicatively coupled to the processing circuit for transmitting and receiving information; and a memory communicatively coupled to the processing circuit for storing information. The processing circuit is configured to generate a first set of instructions for animation of one or more characters; generate a second set of instructions for animation of one or more environments; extract a first set of dialogue elements from a conversant input received in an affective objects module of the processing circuit; extract a second set of dialogue elements from a natural language system output; analyze the first and second sets of dialogue elements by an analysis module in the processing circuit for determining emotional content data, the emotion content data used to generate an emotional content report; analyze the first and second sets of dialogue elements by the analysis module in the processing circuit for determining duration data, the duration data used to generated a duration report; and animate the one or more characters and the one or more environments based on the emotional content report and the duration report.

According to one feature, the conversant input is selected from at least one of a verbal communication and a visual communication from a user.

According to another feature, the one or more characters are selected for at least a virtual character and a physical character.

According to yet another feature, the one or more environments are selected for at least a virtual environment and a physical environment.

According to yet another feature, the natural language system output is a physical character such as a robot or robotic system.

### BRIEF DESCRIPTION OF THE DRAWINGS

FIG. 1 illustrates an example of a networked computing platform utilized in accordance with an exemplary embodiment.

FIG. 2 is a flow chart illustrating a method of assessing the semantic mood of an individual, in accordance with an exemplary embodiment.

FIGS. 3A and 3B illustrate a flow chart of a method of extracting semantic data from conversant input, according to one example.

FIG. 4 illustrates representations of moods of an individual based on facial expressions, according to one example.

FIG. 5 illustrates a graph for plotting an individual's mood or emotions in real time.

FIG. 6 illustrates an example of Plutchik's wheel of emotions.

FIG. 7 illustrates a computer implemented method for executing cinematic direction and dynamic character control via natural language output, according to one example.

FIG. 8 is a diagram illustrating an example of a hardware implementation for a system configured to measure semantic affect, emotion, intention and sentiment via relational input vectors using national language processing.

FIG. 9 is a diagram illustrating an example of the modules/circuits or sub-modules/sub-circuits of the affective objects module or circuit of FIG. 8.

### DETAILED DESCRIPTION

The following detailed description is of the best currently contemplated modes of carrying out the present disclosure. The description is not to be taken in a limiting sense, but is made merely for the purpose of illustrating the general principles of the invention.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

As known to those skilled in the art, an avatar is a virtual representation of an individual within a virtual environment. Avatars often include physical characteristics, statistical attributes, inventories, social relations, emotional representations, and weblogs (blogs) or other recorded historical data. Avatars may be human in appearance, but are not limited to any appearance constraints. Avatars may be personifications of a real world individual, such as a Player Character (PC) within a Massively Multiplayer Online Games (MMOG), or may be an artificial personality, such as a Non-Player Character (NPC). Additional artificial personality type avatars may include, but are not limited to, personal assistants, guides, educators, answering servers and information providers. Additionally, some avatars may have the ability to be automated some of the time, and controlled by a human at other times. Such Quasi-Player Characters (QPCs) may perform mundane tasks automatically, but more expensive human agents take over in cases of complex problems.

The avatar driven by the autonomous avatar driver may be generically defined. The avatar may be a character, non-player character, quasi-player character, agent, personal assistant, personality, guide, representation, educator or any additional virtual entity within virtual environments. Avatars may be as complex as a 3D rendered graphical embodiment that includes detailed facial and body expressions, it may be a hardware component, such as a robot, or it may be as simple as a faceless, non-graphical widget, capable of limited, or no function beyond the natural language interaction of text. In a society of ever increasing reliance and blending between real life and our virtual lives, the ability to have believable and useful avatars is highly desirable and advantageous.

In addition to avatars or virtual characters, the present disclosure may also be directed to physical characters such as robots or robotic systems. Additionally, environments may be directed to virtual environments as well as physical environments. The instructions and/or drivers generated in the present disclosure may be utilized to animate virtual characters as well as physical characters. The instructions and/or drivers generated in the present disclosure may be utilized to animate virtual environments as well as physical environments.

### Networked Computing Platform

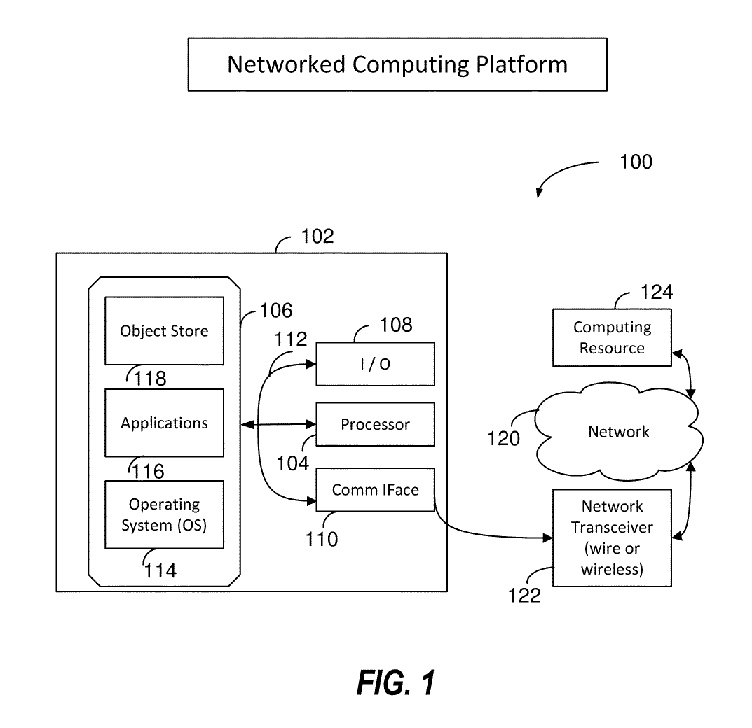

FIG. 1 illustrates an example of a networked computing platform utilized in accordance with an exemplary embodiment. The networked computing platform 100 may be a general mobile computing environment that includes a mobile computing device and a medium, readable by the mobile computing device and comprising executable instructions that are executable by the mobile computing device. As shown, the networked computing platform 100 may include, for example, a mobile computing device 102. The mobile computing device 102 may include a processing circuit 104 (e.g., processor, processing module, etc.), memory 106, input/output (I/O) components 108, and a communication interface 110 for communicating with remote computers or other mobile devices. In one embodiment, the afore-mentioned components are coupled for communication with one another over a suitable bus 112.

The memory 106 may be implemented as non-volatile electronic memory such as random access memory (RAM) with a battery back-up module (not shown) such that information stored in memory 106 is not lost when the general power to mobile device 102 is shut down. A portion of memory 106 may be allocated as addressable memory for program execution, while another portion of memory 106 may be used for storage. The memory 106 may include an operating system 114, application programs 116 as well as an object store 118. During operation, the operating system 114 is illustratively executed by the processing circuit 104 from the memory 106. The operating system 114 may be designed for any device, including but not limited to mobile devices, having a microphone or camera, and implements database features that can be utilized by the application programs 116 through a set of exposed application programming interfaces and methods. The objects in the object store 118 may be maintained by the application programs 116 and the operating system 114, at least partially in response to calls to the exposed application programming interfaces and methods.

The communication interface 110 represents numerous devices and technologies that allow the mobile device 102 to send and receive information. The devices may include wired and wireless modems, satellite receivers and broadcast tuners, for example. The mobile device 102 can also be directly connected to a computer to exchange data therewith. In such cases, the communication interface 110 can be an infrared transceiver or a serial or parallel communication connection, all of which are capable of transmitting streaming information.

The input/output components 108 may include a variety of input devices including, but not limited to, a touch-sensitive screen, buttons, rollers, cameras and a microphone as well as a variety of output devices including an audio generator, a vibrating device, and a display. Additionally, other input/output devices may be attached to or found with mobile device 102.

The networked computing platform 100 may also include a network 120. The mobile computing device 102 is illustratively in wireless communication with the network 120—which may for example be the Internet, or some scale of area network—by sending and receiving electromagnetic signals of a suitable protocol between the communication interface 110 and a network transceiver 122. The network transceiver 122 in turn provides access via the network 120 to a wide array of additional computing resources 124. The mobile computing device 102 is enabled to make use of executable instructions stored on the media of the memory 106, such as executable instructions that enable computing device 102 to perform steps such as combining language representations associated with states of a virtual world with language representations associated with the knowledgebase of a computer-controlled system (or natural language processing system), in response to an input from a user, to dynamically generate dialog elements from the combined language representations.

### Semantic Mood Assessment

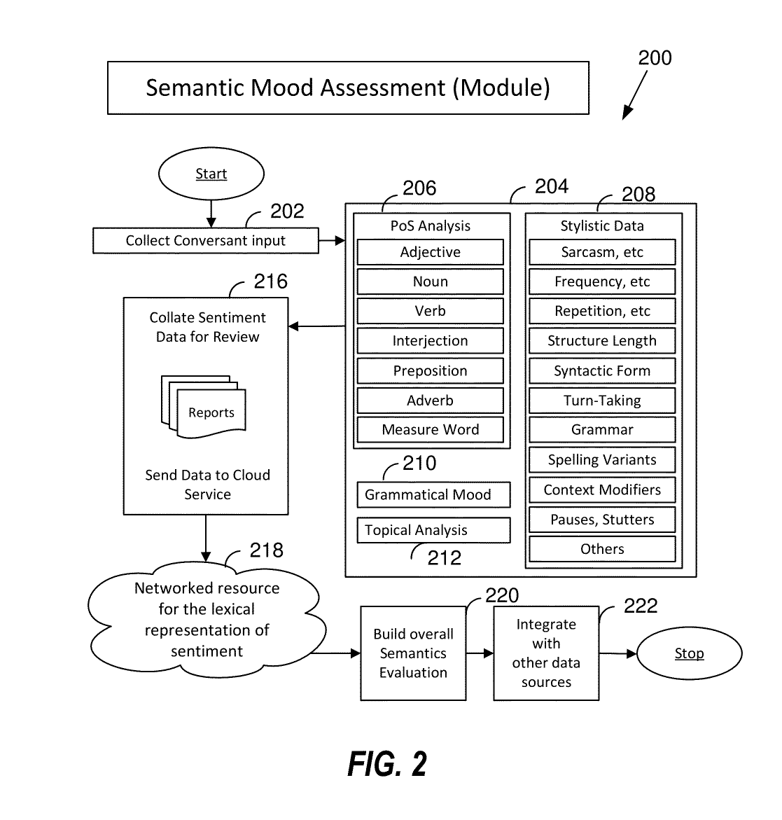

FIG. 2 is a flow chart illustrating a method of assessing the semantic mood of an individual, in accordance with an exemplary embodiment. First, conversant input from a user may be collected 202. The conversant input may be in the form of audio, visual or textual data generated via text, sensor-based data such as heartrate or blood pressure, gesture (e.g. of hands or posture of body), facial expression, tone of voice, region, location and/or spoken language provided by users.

According to one example, the conversant input may be spoken by an individual speaking into a microphone. The spoken conversant input may be recorded and saved. The saved recording may be sent to a voice-to-text module which transmits a transcript of the recording. Alternatively, the input may be scanned into a terminal or may be a graphic user interface (GUI).

Next, a semantic module may segment and parse the conversant input for semantic analysis 204. That is, the transcript of the conversant input may then be passed to a natural language processing module which parses the language and identifies the intent of the text. The semantic analysis may include Part-of-Speech (PoS) Analysis 206, stylistic data analysis 208, grammatical mood analysis 210 and topical analysis 212.

In PoS Analysis 206, the parsed conversant input is analyzed to determine the part or type of speech in which it corresponds to and a PoS analysis report is generated. For example, the parsed conversant input may be an adjective, noun, verb, interjections, preposition, adverb or a measured word. In stylistic data analysis 208, the parsed conversant input is analyzed to determine pragmatic issues, such as slang, sarcasm, frequency, repetition, structure length, syntactic form, turn-taking, grammar, spelling variants, context modifiers, pauses, stutters, grouping of proper nouns, estimation of affect, etc. A stylistic analysis data report may be generated from the analysis. In grammatical mood analysis 210, the grammatical mood of the parsed conversant input may be determined Grammatical moods can include, but are not limited to, interrogative, declarative, imperative, emphatic and conditional. A grammatical mood report may be generated from the analysis. In topical analysis 212, a topic of conversation may be evaluated to build context and relational understanding so that, for example, individual components, such as words may be better identified (e.g., the word “star” may mean a heavenly body or a celebrity, and the topic analysis helps to determine this). A topical analysis report may be generated from the analysis.

Once the parsed conversant input has been analyzed, all the reports relating to sentiment data of the conversant input may be collated 216. As described above, these reports may include, but are not limited to a PoS report, a stylistic data report, grammatical mood report and topical analysis report. The collated reports may be stored in the Cloud or any other storage location.

Next, from the generated reports, the vocabulary or lexical representation of the sentiment of the conversant input may be evaluated 218. The lexical representation of the sentiment of the conversant input is a network object that evaluates all the words identified (i.e. from the segmentation and parsing) from the conversant input, and references those words to a likely emotional value that is then associated with sentiment, affect, and other representations of mood.

Next, using the generated reports and the lexical representation, an overall semantics evaluation may be built or generated 220. That is, the system generates a recommendation as to the sentiment and affect of the words in the conversant input. This semantic evaluation may then compared and integrated with other data sources 222.

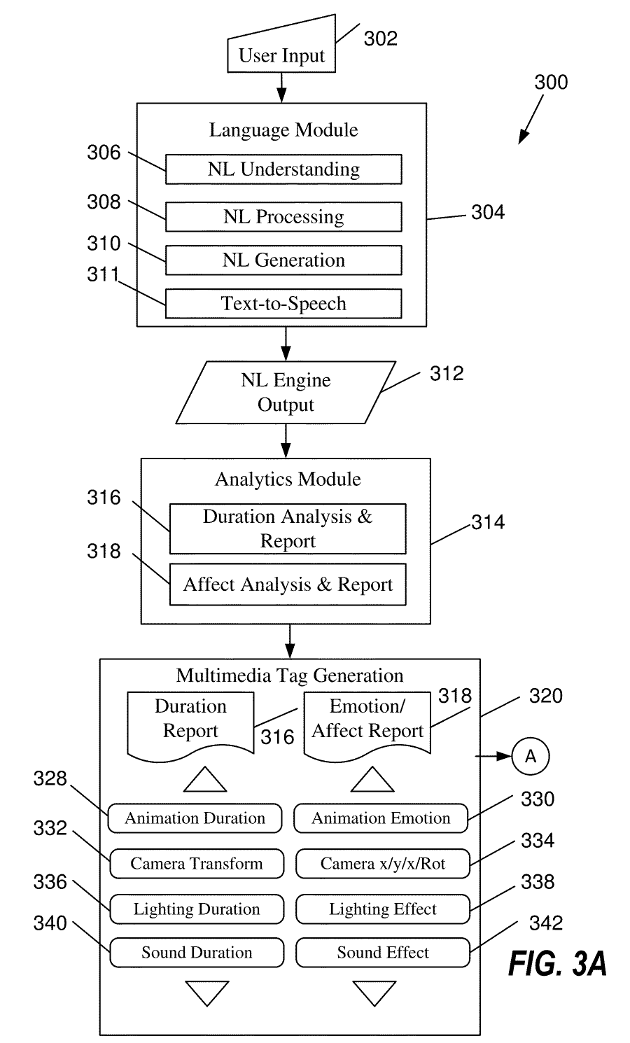

FIGS. 3A and 3B illustrate a flow chart 300 of a method of extracting semantic data from conversant input, according to one example. Semantic elements, or data, may be extracted from a dialogue between a software program and a user, or between two software programs, and these dialogue elements may be analyzed to orchestrate an interaction that achieves emotional goals set forth in the computer program prior to initiation of the dialogue.

In the method, first, user input 302 (i.e. conversant input or dialogue) may be input into a language module 304 for processing the user input. The user input may be in the form of audio, visual or textual data generated via text, gesture, and/or spoken language provided by users. The language module 304 may include a natural language understanding module 306, a natural language processing module 308 and a natural language generation module 310. In some configurations, the language module 304 may optionally include a text-to-speech module 311 which would also generate not just the words, but the sound that conveys them, such as the voice.

The natural language module 306 may recognize the parts of speech in the dialogue to determine what words are being used. Parts of speech can include, but are not limited to, verbs, nouns, adjectives, adverbs, pronouns, prepositions, conjunctions and interjections. Next, the natural language processing module 308 may generate data regarding what the relations are between the words and what the relations mean, such as the meaning and moods of the dialogue. Next, the natural language generation module 310 may generate what the responses to the conversant input might be.

The natural language engine output 312 may output data which may be in the form of, for example, text, such as a natural language sentence written in UTF8 or ASCII, an audio file which is recorded and stored in an audio file such as WAV, MP3, AIFF (or any of type of format known in the art for storing sound data). The output data may then be input into an analytics module 314. The analytics module 314 may utilize the output data from the natural engine output module 312. The analytics module 314 may analyze extracted elements for duration and generate a duration report 316. Furthermore, the analytics module 314 may analyze extracted elements for emotional content/affect and generate an emotional content/affect report 318. This emotional content may identify the mood of the data based on a number of vectors that are associated with an external library, such as are currently used in the detection of sentiment and mood for vocal or textual bodies of data. Many different libraries, with many different vectors may be applied to this method.

Next, the duration report 316 and the emotion/affect report 318 may be sent to a multimedia tag generation module 320. The multimedia tag generation module 320 may utilize the data in the duration and emotion/affect reports 316, 318 to generate a plurality of tag pairs where each tag in the tag pair may be used to define or identify data used to generate an avatar and/or virtual environment. That is, each tag may be used to generate avatar animations or other modifications of the environmental scene. As shown in FIG. 3A, the plurality of tag pairs may include, but is not limited to, animation duration and emotion tags 328, 330; camera transform and camera x/y/x/Rotation tags 332, 334; lighting duration and effect tags 336, 338; and sound duration and effect tags 340, 342 Animation is not limited to character animation but may include any element in the scene or other associated set of data so that, for example, flowers growing in the background may correspond with the character expressing joy, or rain might begin, and the flowers would wilt to express sadness.

Next, the tags from the tag generation module 320 may be input into a control file 344. The control file 344 may drive the avatar animation and dynamically make adjustments to the avatar and/or virtual environment. In other words, the control file 344 may be used to drive the computer screen with linguistic data. For example, each tag pair guides the system in generating (or animating) the avatar (or virtual character) and the virtual scene (or virtual environment). This method may also be applied to driving the animation of a hardware robot. For example, the character may be a physical character. Furthermore, the environment may be a physical environment in addition to or instead of a virtual environment.

As shown in FIG. 3B, the control file 344 may include multiple datasets containing data for creating the avatars and virtual environments. For example, the multiple folders may include, but are not limited to, multiple animation files (“Anims”), camera files (“Cams”), lights files (“Lights”), sound files (“Snds”) and other files (“Other”). The “Anims” may include various episodes, acts, scenes, etc. Alternatively, “Anims” may include language spoken by the avatar or virtual character, animation of the avatar or virtual character, etc. The “Cams” files may include camera position data, animation data, etc. The “Lights” files may include light position data, type of light data, etc. The “Snds” files may include music data, noise data, tone of voice data and audio effects data. The “Other” files may include any other type of data that may be utilized to create the avatars and virtual environments, nodes that provide interactive controls (such a proximity sensors or in-scene buttons, triggers, etc) or other environmental effects such as fog, additional elements such as flying birds, event triggers such as another avatar appearing at that cued moment.

Next, the control file 344 may send the data to a device 346, such as a mobile device (or other computer, connected device such as a robot) for manipulating the avatar and virtual environment data.

Animating Emotions with Fibonacci Chains and Iconic Gestures

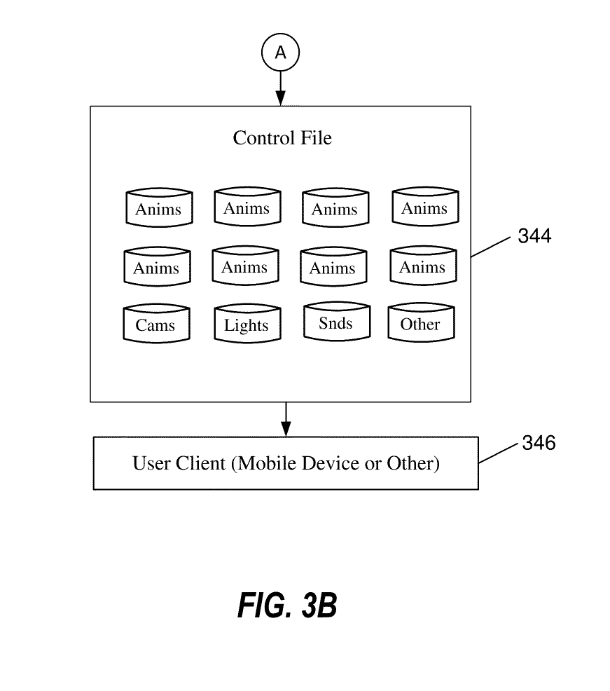

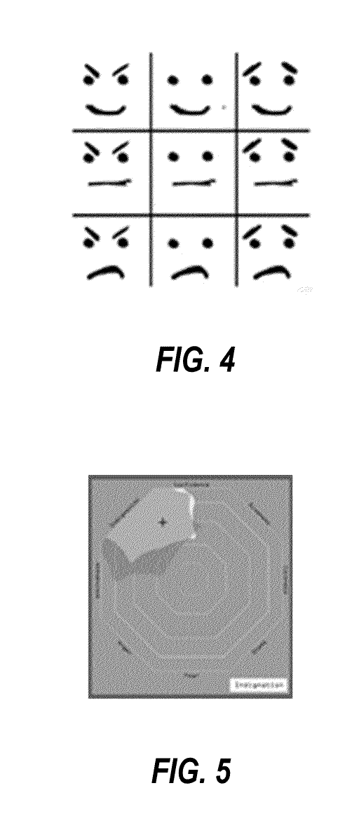

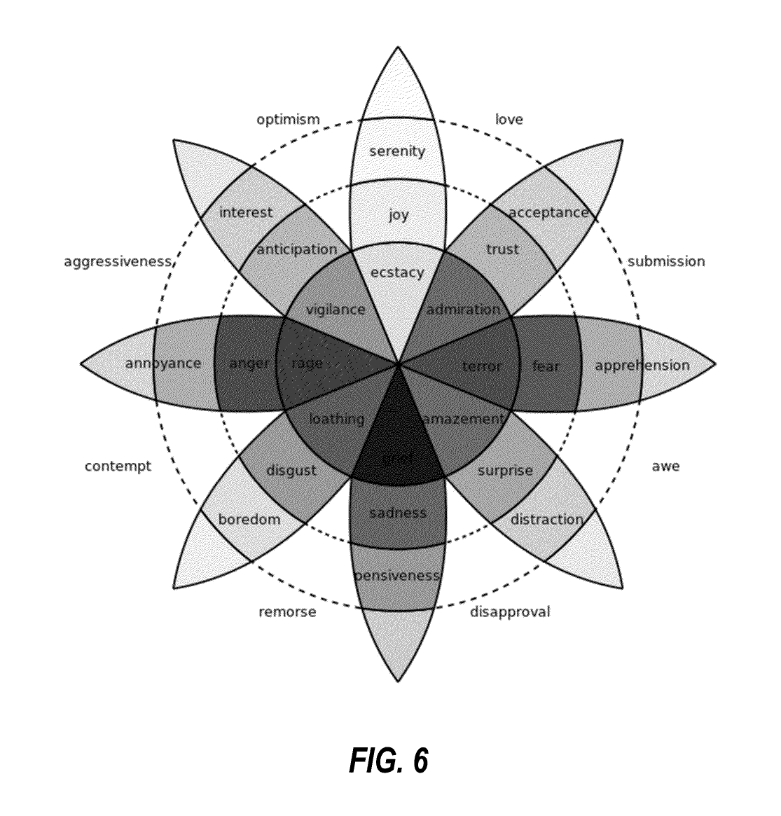

FIG. 4 illustrates representations of moods of an individual based on facial expressions, according to one example. The facial expressions may be associated with an emotional value that is associated with sentiment of an emotion, affect or other. FIG. 5 illustrates a graph for plotting an individual's mood or emotions in real time. Although eight (8) emotions are shown, this is by way of example only and the graph may plot more than eight (8) emotions or less than eight (8) emotions. According to one example, the graph may also include a single, nul/non-emotion. An example of a similar model is Plutchik's wheel of emotions which is shown in FIG. 6. According to one example, each side of the octagonal shaped graph may represent an emotion, such as confidence, kindness, calmness, shame, fear, anger, unkindness and indignation. However, unlike Plutchik's wheel of emotions, the further outward from the center of the wheel the stronger the emotions are. For example, annoyance would be closer to neutral, then anger and then rage. As another example, apprehension would be closer to neutral, then fear and then terror.

Animating Emotions with Fibonacci Chains

According to one example, eight (8) 42-second animations may be built. Each of the eight animations may correspond to the list of eight emotions. Two nul/non-emotion animations of the same duration may be made, giving a total of ten animations. Each of the 42-second animations may be split into a Fibonacci sequence of 1, 1, 2, 3, 5, 8, and 13 second durations. These animation links may be saved for later use, and reside on the user client platform 346.

The natural language processing (NLP) system may produce a block of output text of undetermined duration (the time it takes to speak that text) and undetermined emotion (the sentiment of the text). Next, animation may be provided that roughly matches that emotion and duration without having repeated animations happening adjacent to one another. The natural language processing system may be a virtual character or a physical character. For example, the natural language processing system may be a robot or a robotic system.

A block of output text may be evaluated so as to determine two values. The first value may be the duration which is listed in seconds (i.e. duration data). The duration may be based on the number of bytes if using a text-to-speech (TTS) system, or recording length, or whatever to determine how long it takes to speak it. The second value may be the sentiment or emotional content (i.e. emotional content data) which is listed as an integer from 0-8, to correspond with our emotional model, which corresponds to the emotion number.

### Generating the Chain Animation

The Multimedia Tag Generation Module 320 builds a control file 344 which lists the chain animation, composed of these links. It is assigned a name based on these summary values, for example 13_{—}7 for emotion number seven at 13 seconds.

These two values may then be used to determine the duration and emotion of the composed, or chained, animation. This chained animation is a sequence of the links mentioned above generated by interpolating between the end-values and start-values of successive link animations. Care must be given to avoid repeated animations.

Additionally, so as to avoid repetitions, the Multimedia Tag Generation Module 320 may also confirm that this sequence has not been recently sent, and if it has then the specific orders of the links are changed so that the total sum is the same, but the order of the links are different. In this manner a 13 second animation which was previously built of the links 8+5 might instead be sent a second time as 5+8 or as 2+3+8 or 5+3+5 or any number of other variations equaling the same sum duration.

According to one aspect, the system may have the ability to self-modify (i.e. self-training) when the system is attached to another system that allows it to perceive converstants and other systems provide it with examples of elements such as iconic gesture methods.

### Iconic Gestures

At particular moments that require particular emphasis, Iconic Gestures may be used to break this up and bring attention to the words being said such that the Iconic Gesture matches the duration and sentiment of what is being said.

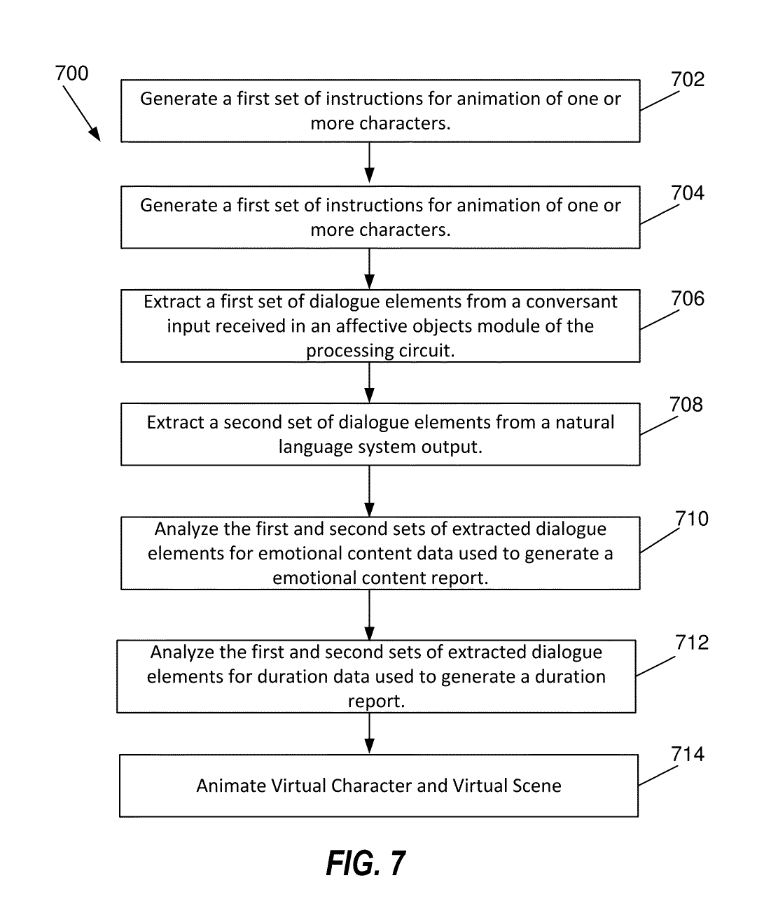

FIG. 7 illustrates a computer implemented method 700 for executing cinematic direction and dynamic character control via natural language output, according to one example. First, a first set of instructions for animation of one or more characters is generated 702. The characters may be virtual and/or physical characters. Next, a second set of instructions for animation of one or more environments is generated. The environments may be virtual and/or physical environments.

A first set of dialogue elements may be extracted from a conversant input received in an affective objects module of the processing circuit 706. The conversant input may be selected from at least one of a verbal communication and a visual communication from a user. A second set of dialogue elements may be extracted from a natural language system output 708. The natural language output system may be a virtual character or a physical character such as a robot or robotic system.

Next, the first and second sets of dialogue elements may be analyzed by an analysis module in the processing circuit for determining emotional content data, the emotion content data used to generate an emotional content report 710. The first and second sets of dialogue elements may then be analyzed by the analysis module in the processing circuit for determining duration data, the duration data used to generate a duration report 712. Finally, the one or more characters and the one or more environments may be animated based on the emotional content report and the duration report 714.

### Device

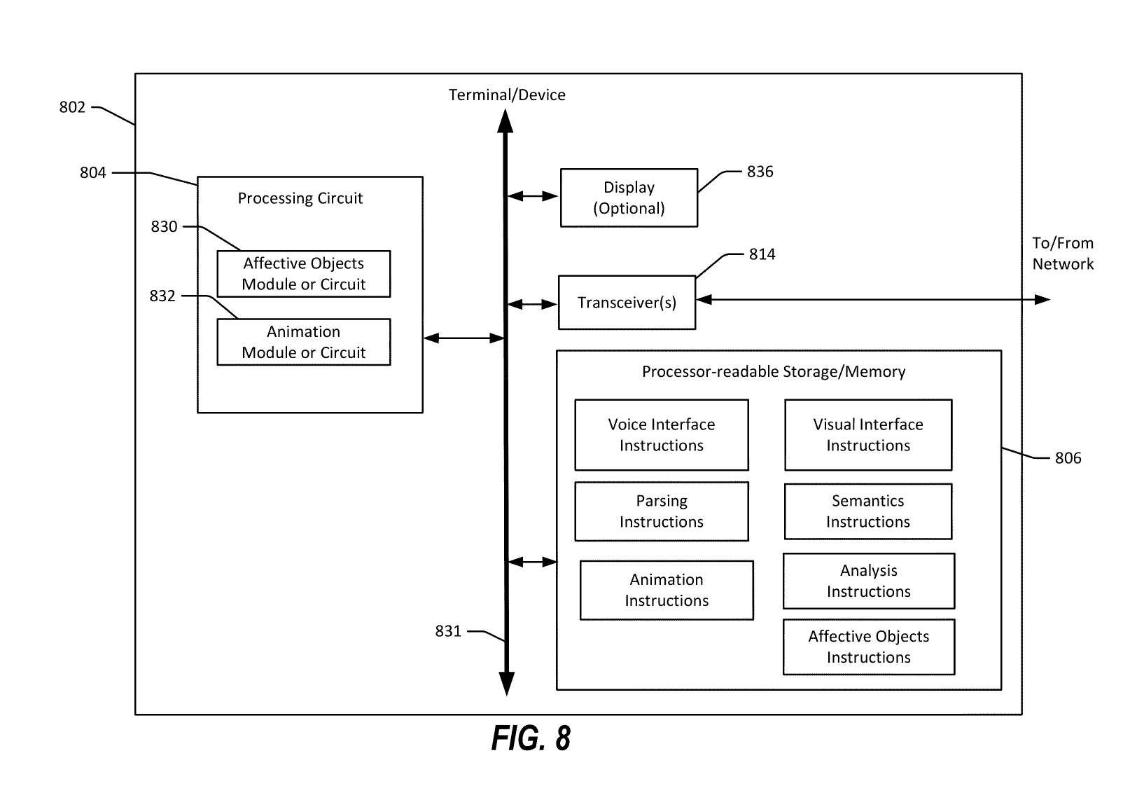

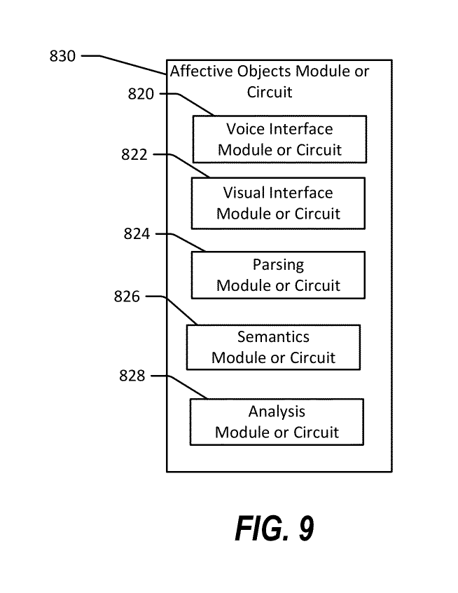

FIG. 8 is a diagram 800 illustrating an example of a hardware implementation for a system 802 configured to measure semantic affect, emotion, intention and sentiment via relational input vectors using national language processing. FIG. 9 is a diagram illustrating an example of the modules/circuits or sub-modules/sub-circuits of the affective objects module or circuit of FIG. 8.

The system 802 may include a processing circuit 804. The processing circuit 804 may be implemented with a bus architecture, represented generally by the bus 831. The bus 831 may include any number of interconnecting buses and bridges depending on the application and attributes of the processing circuit 804 and overall design constraints. The bus 831 may link together various circuits including one or more processors and/or hardware modules, processing circuit 804, and the processor-readable medium 806. The bus 831 may also link various other circuits such as timing sources, peripherals, and power management circuits, which are well known in the art, and therefore, will not be described any further.

The processing circuit 804 may be coupled to one or more communications interfaces or transceivers 814 which may be used for communications (receiving and transmitting data) with entities of a network.

The processing circuit 804 may include one or more processors responsible for general processing, including the execution of software stored on the processor-readable medium 806. For example, the processing circuit 804 may include one or more processors deployed in the mobile computing device 102 of FIG. 1. The software, when executed by the one or more processors, cause the processing circuit 804 to perform the various functions described supra for any particular terminal. The processor-readable medium 806 may also be used for storing data that is manipulated by the processing circuit 804 when executing software. The processing system further includes at least one of the modules 820, 822, 824, 826, 828, 830 and 832. The modules 820, 822, 824, 826, 828, 830 and 832 may be software modules running on the processing circuit 804, resident/stored in the processor-readable medium 806, one or more hardware modules coupled to the processing circuit 804, or some combination thereof.

In one configuration, the mobile computer device 802 for wireless communication includes a module or circuit 820 configured to obtain verbal communications from an individual verbally interacting (e.g. providing human or natural language input or conversant input) to the mobile computing device 802 and transcribing the natural language input into text, module or circuit 822 configured to obtain visual communications from an individual interacting (e.g. appearing in front of) a camera of the mobile computing device 802, and a module or circuit 824 configured to parse the text to derive meaning from the natural language input from the authenticated consumer. The processing system may also include a module or circuit 826 configured to obtain semantic information of the individual to the mobile computing device 802, a module or circuit 828 configured to analyze extracted elements from conversant input to the mobile computing device 802, a module or circuit 830 configured to determine and/or analyze affective objects in the dialogue, and a module or circuit 832 configured to generate or animate the virtual character (avatar) and/or virtual environment or scene.

In one configuration, the mobile communication device 802 may optionally include a display or touch screen 836 for receiving and displaying data to the consumer.

One or more of the components, steps, and/or functions illustrated in the figures may be rearranged and/or combined into a single component, step, or function or embodied in several components, steps, or functions without affecting the operation of the communication device having channel-specific signal insertion. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A computer implemented method for executing cinematic direction and dynamic character control via natural language output, comprising executing on a processing circuit of a computer terminal the steps of:
generating a first set of instructions for animation of one or more characters;
generating a second set of instructions for animation of one or more environments;
extracting a first set of dialogue elements from a conversant input received in an affective objects module of the processing circuit;
extracting a second set of dialogue elements from a natural language system output;
analyzing the first and second sets of dialogue elements by an analysis module in the processing circuit for determining emotional content data, the emotion content data used to generate an emotional content report;
analyzing the first and second sets of dialogue elements by the analysis module in the processing circuit for determining duration data, the duration data used to generated a duration report; and
animating the one or more characters and the one or more environments based on the emotional content report and the duration report.

2. The method of claim 1, wherein the affective objects module in the computer terminal comprises a parsing module, a voice interface module and a visual interface module.

3. The method of claim 1, wherein the conversant input is selected from at least one of a verbal communication and a visual communication from a user.

4. The method of claim 1, wherein the one or more characters are selected for at least a virtual character and a physical character.

5. The method of claim 1, wherein the one or more environments are selected for at least a virtual environment and a physical environment.

6. The method of claim 1, wherein the natural language system output is a physical character.

7. The method of clam 6, wherein the physical character is a robot.

8. A non-transitory computer-readable medium with instructions stored thereon, that when executed by a processor, perform the steps comprising:
generating a first set of instructions for animation of one or more characters;
generating a second set of instructions for animation of one or more environments;
extracting a first set of dialogue elements from a conversant input received in an affective objects module of the processing circuit;
extracting a second set of dialogue elements from a natural language system output;
analyzing the first and second sets of dialogue elements by an analysis module in the processing circuit for determining emotional content data, the emotion content data used to generate an emotional content report;
analyzing the first and second sets of dialogue elements by the analysis module in the processing circuit for determining duration data, the duration data used to generate a duration report; and
animating the one or more characters and the one or more environments based on the emotional content report and the duration report.

9. The non-transitory computer-readable medium of claim 8, wherein the conversant input is selected from at least one of a verbal communication and a visual communication from a user.

10. The non-transitory computer-readable medium of claim 8, wherein the one or more characters are selected for at least a virtual character and a physical character.

11. The non-transitory computer-readable medium of claim 8, wherein the one or more environments are selected for at least a virtual environment and a physical environment.

12. The non-transitory computer-readable medium of claim 8, wherein the natural language system output is a physical character.

13. The non-transitory computer-readable medium of claim 12, wherein the physical character is a robot.

14. A computer terminal for executing cinematic direction and dynamic character control via natural language output, the terminal comprising:
a processing circuit;
a communications interface communicatively coupled to the processing circuit for transmitting and receiving information; and
a memory communicatively coupled to the processing circuit for storing information, wherein the processing circuit is configured to:
generate a first set of instructions for animation of one or more characters;
generate a second set of instructions for animation of one or more environments;
extract a first set of dialogue elements from a conversant input received in an affective objects module of the processing circuit;
extract a second set of dialogue elements from a natural language system output;
analyze the first and second sets of dialogue elements by an analysis module in the processing circuit for determining emotional content data, the emotion content data used to generate an emotional content report;
analyze the first and second sets of dialogue elements by the analysis module in the processing circuit for determining duration data, the duration data used to generated a duration report; and
animate the one or more characters and the one or more environments based on the emotional content report and the duration report.

15. The computer terminal of claim 10, wherein the conversant input is selected from at least one of a verbal communication and a visual communication from a user.

16. The computer terminal of claim 10, wherein the one or more characters are selected for at least a virtual character and a physical character.

17. The computer terminal of claim 10, wherein the one or more environments are selected for at least a virtual environment and a physical environment.

18. The computer terminal of claim 10, wherein the natural language system output is a physical character.

19. The computer terminal of claim 18, wherein the physical character is a robot.

20. The computer terminal of claim 18, wherein the physical character is a robotic system.
